(19) United States
(12) Patent Application Publication
(10) Pub. No.: US 2016/0035485 A1
(43) Pub. Date: Feb. 4, 2016

(54) Cable-Magnetic Core Winding Approach

(71) Applicant: Andrew David Norte, Westminster, CO (US)

(72) Inventor: Andrew David Norte, Westminster, CO (US)

(73) Assignee: Ricoh Company, Ltd., Tokyo (JP)

(21) Appl. No.: 14/449,886

(22) Filed: Aug. 1, 2014

(51) Int. Cl. H01F 27/33; H01F 27/30; H01F 27/24

(52) U.S. Cl. CPC H01F 27/33; H01F 27/24; H01F 27/306

(57) ABSTRACT

An apparatus is described having a fixture that includes a magnetic core. The fixture is to support winding of a cable around the magnetic core. The fixture has regions where the cable is to be passed through. The regions are arranged to support the winding of the cable around the magnetic core at a substantially fixed distance from the magnetic core's outer surface.

### BACKGROUND

Electronic equipment is often interconnected through the use of some form of communications cable 101. The cable 101 often includes one or more pairs of wires (for convenience FIG. 1 only shows a single pair of wires 102_1, 102_2) to transport a single “signal” where each wire of a pair 102_1, 102_2 transports a signal component that is opposite in polarity to the signal component transported by the other wire.

Thus, as observed in FIG. 1, wire 102_1 carries the positive (+) end of the transmitted signal and wire 102_2 carries the negative (−) end of the transmitted signal. Signals that are transmitted in this manner are referred to as “differential” signals because the transmitted signal is defined as the difference between the respective signals that exist on the two wires. Differential signals are used in part because they have twice (3 dB) the signal strength of a single-ended transmission (i.e., A−(−A)=2A).

### FIGURES

A better understanding of the present invention can be obtained from the following detailed description in conjunction with the following drawings, in which:

FIG. 1 (prior art) shows a cable wound around a ferrite core toroid;

FIGS. 2a and 2b show two different embodiments of a new improved manner of winding a cable around a ferrite core;

FIG. 3 shows channel characteristics that compare differential vs. common mode signal attenuation with the improved approach;

FIGS. 4a and 4b show structures for effecting the improved winding approach.

### DETAILED DESCRIPTION

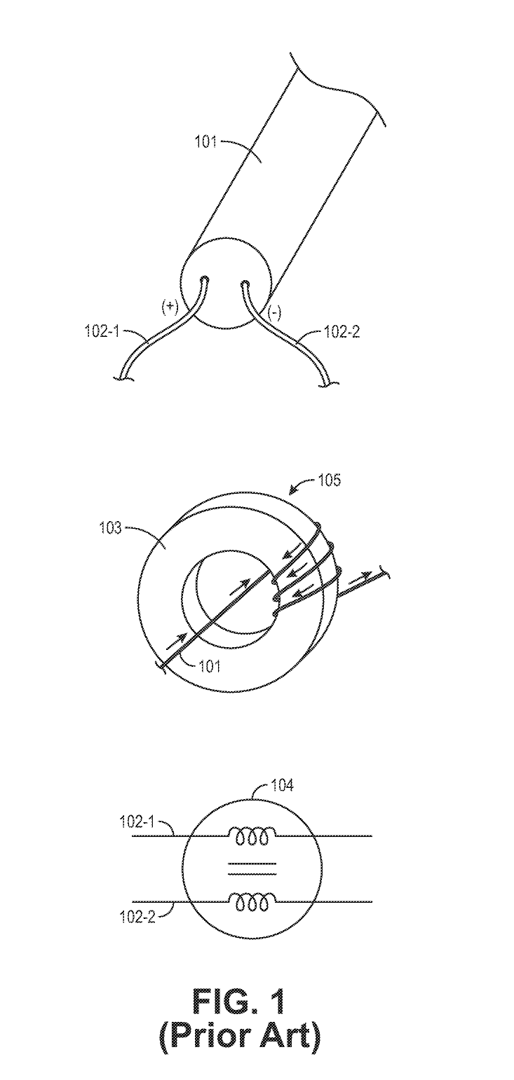

A problem with the cable arrangement of FIG. 1 is that the longer the length of the cable 101 the greater its propensity to behave like an antennae and receive unwanted electromagnetic signals or “noise”. In order to suppress the noise, also as observed in FIG. 1 at inset 105, the cable 101 has traditionally been wrapped around a ferrite core 103. The wrapping of the cable 101 around the ferrite core 103 essentially forms an inductor 104 in the channel direction along the cable.

As is known in the art the inductor 104 has both a differential aspect and a common mode aspect. The differential aspect characterizes the inductor's ability to attenuate the frequencies of a differential signal. By contrast, the common mode aspect characterizes the inductor's ability to attenuate the frequencies of a common mode signal. A common mode signal is the logical opposite of a differential signal. That is, whereas a differential signal is defined by a pair of signal ends having opposite polarity, a common mode signal is defined by signal ends having same polarity (e.g., two identical signals on wires 102_1, 102_2 rather than opposing signals on wires 102_1, 102_2).

The undesirable noise that is received by the antennae behavior of the cable 101 is typically in the form of a common mode signal rather than a differential signal. That is, the noise that is generated on wires 102_1, 102_2 is typically of same polarity rather than opposite polarity.

Thus, in forming the inductor 104, the hope is that the common mode inductance is sufficiently high so as to attenuate the common mode noise and that the differential mode inductance is sufficiently low so as to not attenuate the differential signal. If so, the inductor 104 will substantially “filter out” the unwanted noise but permit the differential signal to be passed through the cable. The result should be strong reception of the signal at the receiving end with minimal interference from the noise.

A problem with the approach of FIG. 1 is that the differential and common mode inductances are both complex functions of various factors including the manner in which the cable is wound around the ferrite core, which, as depicted in FIG. 1 includes tightly wrapping the cable around the ferrite core.

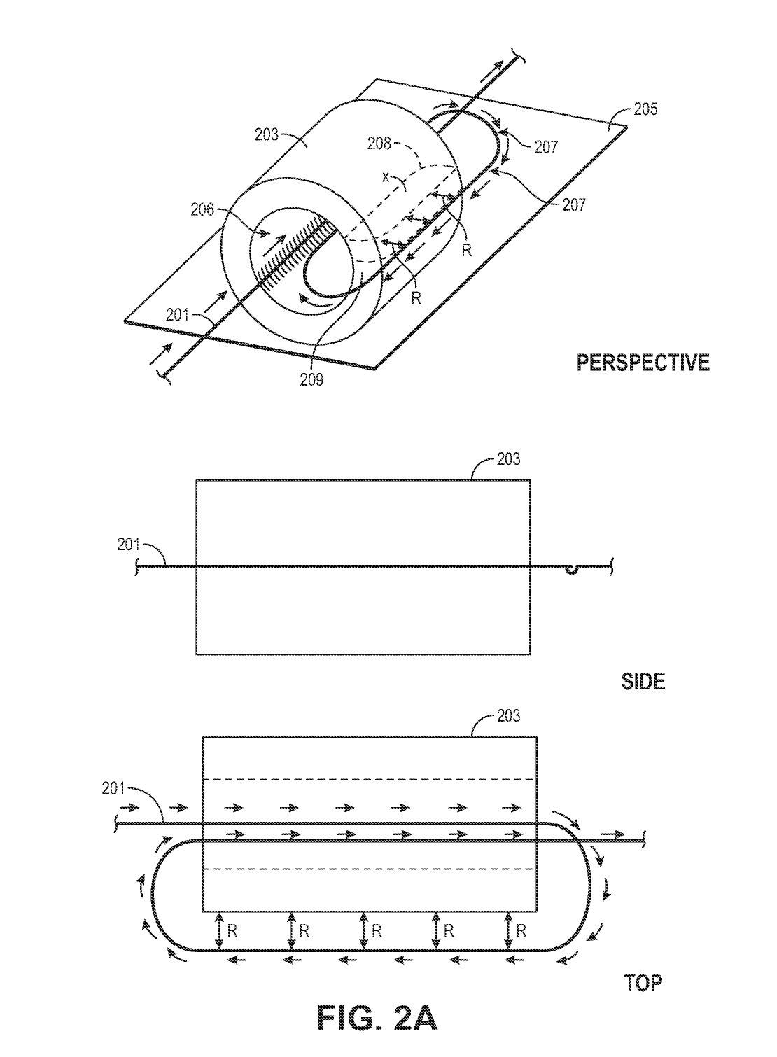

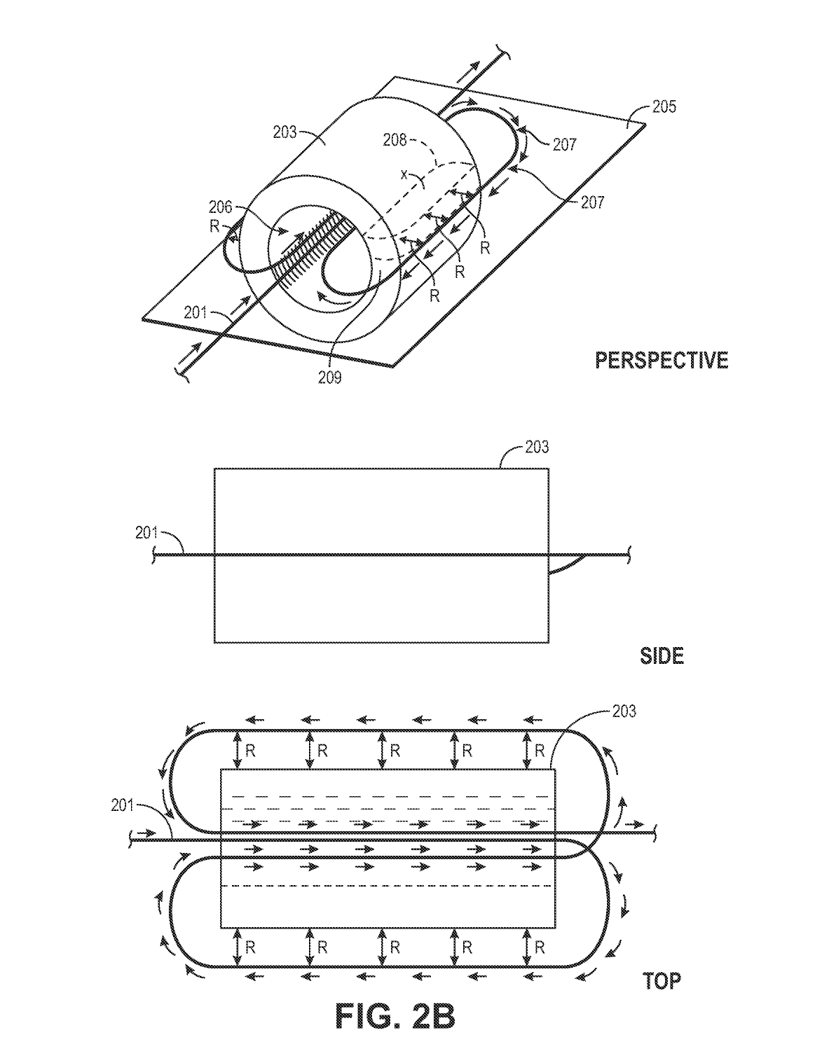

FIGS. 2a and 2b show different embodiments of an improved ferrite core winding approach that appears to have more favorable differential and common mode impedance characteristics for the passing of a differential signal and the rejection of common mode noise than the tightly wound ferrite core approach of FIG. 1.

As observed in FIGS. 2a-b, the improved ferrite core winding approach is characterized by “winding” the cable 201 around the outside of the ferrite core 203 at some fixed distance from the outer surface of the core 203 and around the inside of the core proximately along its length axis rather than tightly around both inner and outer surfaces of the core as in the prior art approach. Additionally, in at least one embodiment, an effort is also made to lay the cable 201 windings substantially along a same plane 205 rather than helically coiling at continually varying levels along the core's radial axis.

FIG. 2a shows a single turn approach in which the cable 201 initially enters the front side hole opening 206 approximately through the center of the opening and continues to run within the core substantially along the core's axis before exiting the back end of the core 203. The cable 201 then winds around 207 the outer surface of the core 203 while substantially maintaining a parallel distance R from the core before re-entering the front side hole opening 206. The cable re-enters the front side hole opening 206 again approximately through its center and runs approximately along the core's axis within the core (e.g., as close as possible to the initial entering run of the cable) and then leaves the winding structure through the back side hole opening of the core 203. As observed in FIG. 2a, an effort is made to keep the cable laying mostly along a same plane (205) as it winds around the core.

FIG. 2b shows a double turn approach in which, again, the cable 201 initially enters the front side opening 206 approximately through its center and runs proximately along the axis of the core before leaving through the back side opening of the core. The cable then winds around 207 the outer surface of the core 203 while substantially maintaining a parallel distance R from the outer surface of the core before re-entering the front side of the hole opening 206 again proximately toward the center of the opening. The cable 201 then runs within the core substantially along the axis of the core (e.g., as close as possible to the initially entering run of the cable before exiting the core's back side opening). The cable 201 then winds around 207 the other outer side of the core while again substantially maintaining the parallel distance R from the outer surface of the core. The cable then again re-enters the front side of the core's hole opening 206 proximately near its center and again runs substantially along the axis of the core (e.g., as close as possible to the other two runs of cable within the core). The cable then exits the winding structure through the core's back side opening. As observed in FIG. 2b, an effort is made to keep the cable laying mostly along a same plane 205 as it winds around the core.

In an embodiment, the parallel distance R is set equal to or approximately equal to 8 W where W is the radius of the wires, and includes the insulation of a wire, within the cable. That is, if one looks at the cross section of a cable there will be respective cross sections of more than one wire where each wire has its own respective insulation. According to this specific embodiment, W is understood to be the complete radius of one wire including both its conductive core and outer insulation. Here, the parallel distance R is defined to be the distance from the outer wall surface 208 of the toroid core to outer insulation of the nearest (“inner”) wire within the cable.

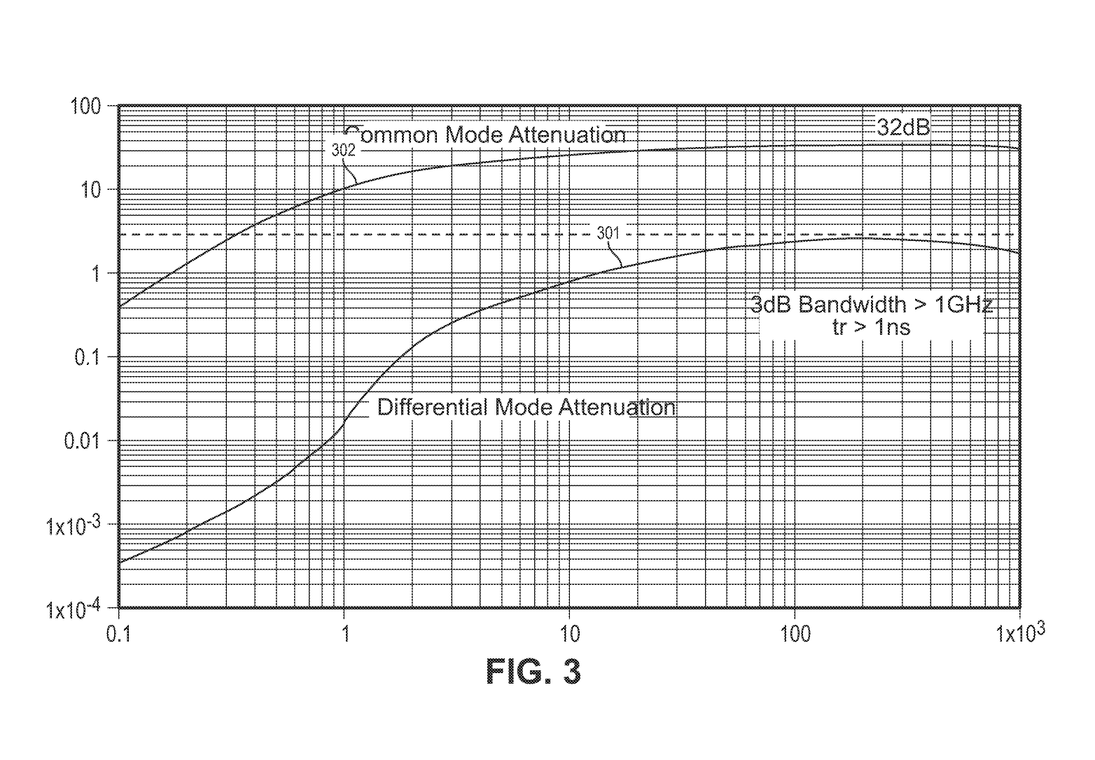

FIG. 3 shows simulated channel transfer characteristics of a cable that has been wound around a ferrite core consistent with the principles discussed just above. The simulated channel transfer characteristics include both characteristics of a differential channel 301 and a common mode channel 302. As can be seen from the characteristic curves 301, 302, the common mode channel has significantly larger attenuation 302 (reduced transmission) than the attenuation 301 of the differential channel. The difference in attenuation between the two curves 301, 302 demonstrates greater rejection/suppression of common mode signals such as received noise than differential signals such as the information being transmitted through the channel. As such, the ferrite core winding approach discussed above with respect to FIGS. 2a and 2b should be well suited maximizing the differential bandwidth for the passing of differential information through the cable while suppressing the common mode noise that it receives.

The suppression of common mode signal energy as opposed to differential signal energy is believed to derive from the geometry of the approach discussed herein in that the radiated energy of both ends of a differential signal whose wire pairs are wound around the core as described above are substantially cancelled out through a local volume 209 that contains plane 205. As a consequence, the differential signal itself is substantially not attenuated.

One way to compare the improvement of the new approach (winding at a distance from the core along a same plane) against the traditional approach (winding closely against the core and not along a same plane) is to recognize that the separation between the cable and core that is imposed by the new approach has the effect of decreasing the inductance that is induced by the ferrite toroid on the differential signals that propagate along cable 201. Embodiments of the ferrite toroid could be rectangular in shape with a rectangular or cylindrical opening in the center of the toroid, or cylindrical in shape with a rectangular or cylindrical opening in the center of the toroid. Thus, increasing the parallel distance R, which is effectively realized with the new approach, corresponds to an increase in distance between the conductors and the toroid and therefore a corresponding decrease in the induced inductance and corresponding decrease in differential attenuation.

A challenge in implementing the improved winding approach of FIGS. 2a and 2b is keeping the cable aligned substantially along a same plane 205 , while maintaining the parallel distance R from the outer surface of toroid 203, and keeping the cable mostly centered through the opening of toroid 203. In particular, a cable winding prefers to orient itself in a helical form as observed in FIG. 1. A helical form essentially corresponds to the antithesis of keeping the cable along a same plane as the plane in which a helically shaped cable resides is continuously changing.

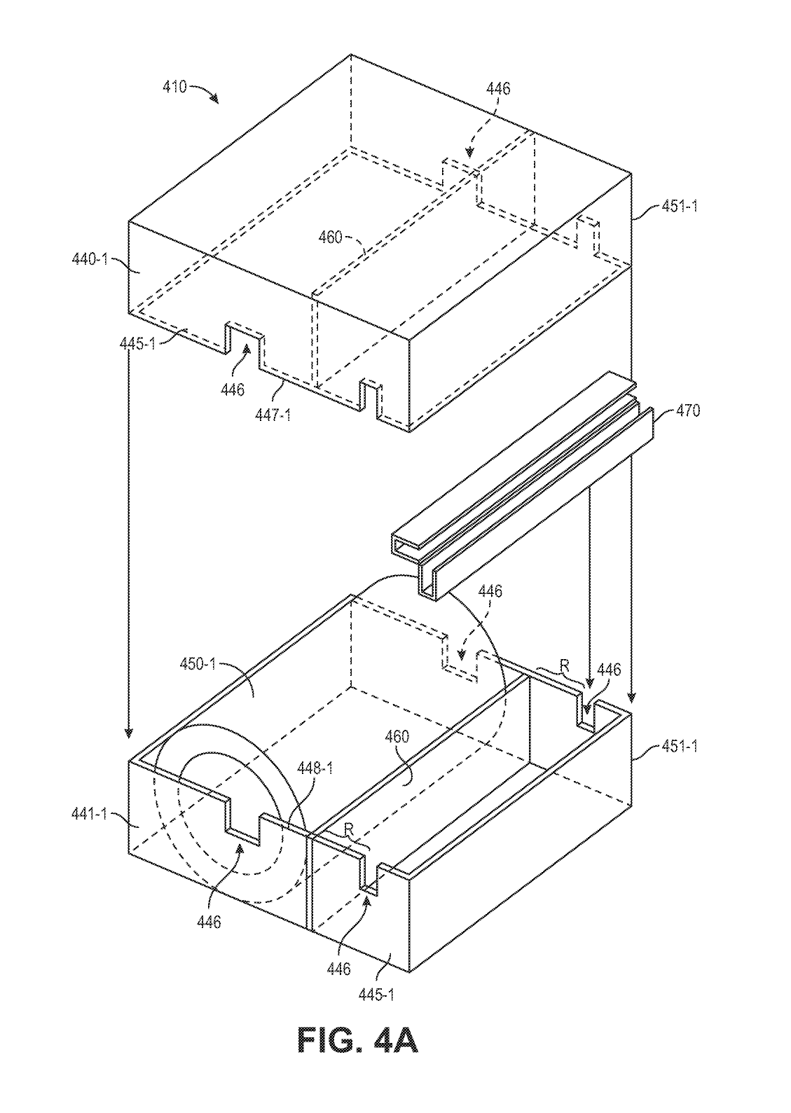

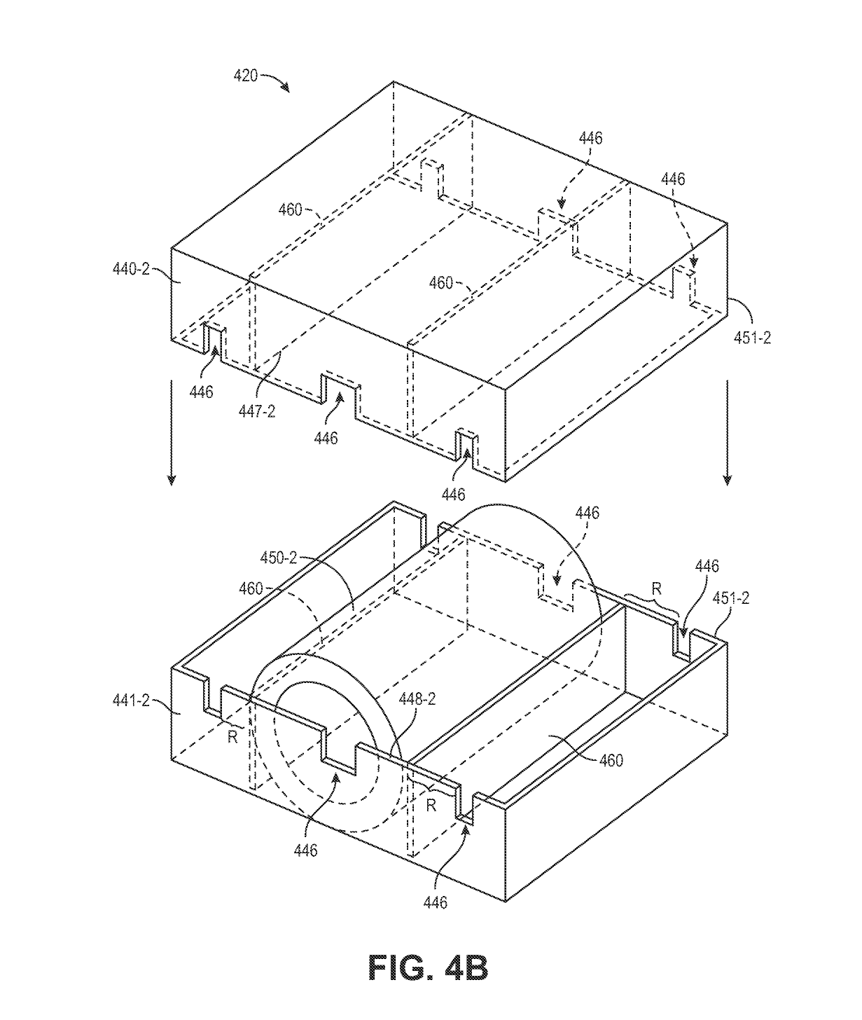

FIGS. 4a and 4b show respective special fixtures 410, 420 that can be used to effect the winding of the cable as observed in FIGS. 2a and 2b, respectively. As depicted, the special fixtures 410, 420 can also be used to maintain a desired winding having parallel distance R (e.g., of 8 W) from the outer surface of the toroid. Here, both fixtures 410, 420 are akin to a box with a top lid 440_1, 440_2 that can be removed from the base 441_1, 441_2 of the box. The ferrite core 450_1, 450_2 is fixed to the base 441_1, 441_2 of the box.

The front face 445_1, 445_2 of the box additionally has holes which are realized through the formation of notches 446 in the lower edge 447_1, 447_2 of the top 440_1, 440_2 of the box and the upper edge 448_1, 448_2 of the base 445_1, 445_2 of the box. Notably, the holes 446 are aligned along a same plane. The back side 451_1, 451_2 of the box is similarly formed notches 446 to act as a exit for the cable from the box.

In order to wind the cable according to the winding approach taught herein, the lid 440_1, 440_2 is first removed from the base 441_1, 441_2 of the box. The cable is then lain on the notches 446 of the upper edge 448_1, 448_2 to effectively layout the cable with the winding around the core along the same plane as desired including through the notches 446 on both the front and back sides of the box Note that the notches in the middle of the core opening may be wider than the notches outside the core to compress the cable lengths that run within core close to one another approximately along the axis of the core. The lid is then placed on the box to hold the cable in place. Clasps (not shown) may be used to clasp/clamp the top and bottom box lids together. The box may be made of any insulating or conductive material.

In one embodiment, a flexible/compressible sleeve is slipped over the core and/or the top and/or bottom box lids are lined with flexible/compressible material to keep the core in place while the top lid is clasped to the bottom lid. In one embodiment, the flexible/compressible material may be present only near the front and back faces of the core (e.g., around the circumference of the core at its front and back ends, on the front and back faces of the core such that it compresses against the front and back faces of the core), etc.). In any of these embodiments, the flexible/compressible material may have a top half that is affixed to the top/lid of the box and a bottom half that is fixed to the bottom of the box.

The box lid and/or bottom may be molded, cut or otherwise formed as solid blocks with appropriately shaped (e.g., cylindrical) cavities to properly hold the core and the cable. Alternatively, as observed in FIG. 4a, the lid and/or bottom of the box may be formed as traditional open box halves with a barrier wall 460 to keep the core in place and/or a separate bridge 470 to hold the run(s) of cable that resides inside the box. For ease of drawing FIG. 4b does not show bridges but two bridges can be used with the embodiment of FIG. 4b

Although “ferrite” cores have been emphasized above, more generally, any magnetic material having an appreciable magnetic permeability may be used. Such magnetic materials may include one or more of: Nickel, Iron, Cobolt, Cromium, Maganese, Zinc. Such magnetic cores may also additionally be composed of one or more electrically isolating materials (e.g., oxides) to reduce the electrical conductivity of the core (e.g., manganese-zinc ferrite; nickel-zinc ferrite; etc.). Laminated or non-laminated cores may be used.

Although a toroid core has been discussed at length above, conceivably, other embodiments of the invention may employ a differently shaped core such as a square/rectangular or cylindrical shaped core (here, the cable should keep a fixed distance from the surfaces of the core as with the toroid). Cores having a thinner depth to them (such that a core that approaches an annulus) may also be used where R corresponds to the radial distance around the core. Generally, families of embodiments may exist where the core has a closed circuit path loop for its internal magnetic flux that circulates around an opening through which the cable can be passed multiple times to effect at least one winding. The opening should be large enough to fit as many cross-sections of the cable are needed given the intended number of windings, and, preserve the designed for distance between the cable and the surface of the magnetic core.

The cable may be any cable having one or more pairs of wires for implementing a differential signal. Examples include twisted-pair and non-twisted pair cables, Ethernet cables, Plain Old Telephone (POTs) cables, etc.

The cable may be cable associated with a printer (e.g., a cable the sends information to and/or from the printer). The structure used to implement the winding (such as the structure embodiments observed in FIG. 4) may be fixed to the electronic equipment (e.g., the printer) or some other structure (e.g., a wall near the printer, an equipment rack or jack-panel in an electrical closet, etc.).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. An apparatus, comprising:
a fixture including a magnetic core, said fixture to support winding of a cable around said magnetic core, said fixture having regions where said cable is to be passed through, said regions being arranged to support said winding of said cable around said magnetic core at a substantially fixed distance from said magnetic core's outer surface.

2. The apparatus of claim 1 wherein said regions are additionally arranged along a same plane to support said winding of said cable along said plane.

3. The fixture of claim 1 wherein a number of said regions is sufficient to support more than one winding around said magnetic core.

4. The fixture of claim 3 wherein said number of said regions is sufficient to support two windings around said core.

5. The fixture of claim 1 wherein said core has any of:
a) a toroid shape;
b) a rectangular shape;
c) a square shape;
d) a cylindrical shape.

6. The fixture of claim 1 wherein said cable is wound around said magnetic core, said cable including one or more pairs of wires for carrying one or more respective differential signals.

7. The fixture of claim 5 wherein said cable is an Ethernet cable.

8. The fixture of claim 4 wherein said pairs of wires are twisted.

9. The fixture of claim 1 wherein said substantially fixed distance is approximately 8 W where W is the radius of the respective wires, including the insulation of a wire, corresponding to ends of opposite polarity of a differential signal.

10. An apparatus, comprising:
an item of electronic equipment; and,
a cable attached to said electronic equipment, said cable having at least one pair of wires to carry a differential signal, said cable running through a fixture, said fixture including a magnetic core, said fixture to support winding of said cable around said magnetic core, said fixture having regions where said cable is passed through, said regions being arranged to support said winding of said cable around said magnetic core at a substantially fixed distance from said magnetic core's outer surface.

11. The apparatus of claim 10 wherein said regions are additionally arranged along a same plane to support said winding of said cable along said plane.

12. The apparatus of claim 10 wherein said cable is wound more than once around said magnetic core.

13. The apparatus of claim 10 wherein said core has a toroid shape.

14. The apparatus of claim 10 wherein said pair of wires are twisted.

15. The apparatus of claim 10 wherein said cable has more than one pair of wires to respectively transport more than one differential signal.

16. The apparatus of claim 10 wherein said cable is an Ethernet cable.

17. The apparatus of claim 10 wherein said substantially fixed distance is approximately 8 W where W is a respective radius of each wire of said pair of wires, including the insulation of the wire.

18. A method, comprising:
opening a fixture having a magnetic core and grooved regions to support a cable;
placing said cable on said grooved regions and winding said cable around said magnetic core at a substantially fixed distance from said magnetic core's outer surface; and,
closing said fixture to hold said cable in place on said grooved regions.

19. The method of claim 18 wherein said grooved regions lie substantially along a same plane.

20. The method of claim 18 wherein said magnetic core has any of:
a) a toroid shape;
b) a rectangular shape;
c) a square shape;
d) a cylindrical shape.
